(19) United States
(12) Patent Application Publication
(10) Pub. No.: US 2008/0206596 A1
(43) Pub. Date: Aug. 28, 2008

(54) Red phosphors with High Luminus Efficiency and Display Device Containing Them

(75) Inventors: So-young Jung, Seoul (KR); Kyu-sung Cho, Kyeongki-do (KR); Sung-min Chin, Chungcheong-bukdo (KR); Kyung-hoon Choi, Seoul (KR); Jung-soo Kwon, Seoul (KR); Mi-young Kwak, Seoul (KR); No-gill Park, Seoul (KR); Bong-ok Kim, Seoul (KR); Sung-min Kim, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: GRACEL DISPLAY INC., Seoul (KR)

(21) Appl. No.: 11/814,893

(22) PCT Filed: Jan. 18, 2006
(86) PCT No.: PCT/KR06/00188

§ 371 Date: Jul. 26, 2007

(30) Foreign Application Priority Data
Jan. 31, 2005 (KR) 10-2005-0008862

(51) Int. Cl. C09K 11/06; C07F 15/00

(52) U.S. Cl. 428/690; 546/2

(57) ABSTRACT

The present invention relates to a novel red organic electrophosphorescent compound and a display device comprising the same. The phosphor compounds according to the present invention provide red phosphor compounds exhibiting more pure red color than conventional red phosphors and red phosphors having a light emitting property of high efficiency even in a low doping concentration, as well as the property of pure red color mentioned above.

### FIELD OF THE INVENTION

The present invention relates to red electroluminescent iridium compounds and display devices employing the same as a light emitting dopant. More specifically, it relates to novel iridium compounds which have red electroluminescent property of high efficiency and can be used as a substance to form a light emitting layer of a light emitting device, and display devices employing the compounds as a light emitting dopant.

### BACKGROUND OF THE RELATED ART

Among display devices, electroluminescence (EL) devices, being self-luminous type display devices, have advantages of wide visual angle, excellent contrast as well as rapid response rate.

Meanwhile, Eastman Kodak firstly developed an organic EL device employing low molecular aromatic diamine and aluminum complex as a substance for forming a light emitting layer, in 1987 [Appl. Phys. Lett. 51, 913, 1987].

The most important factor to determine luminous efficiency in an organic EL device is light emitting material. Though fluorescent materials have been widely used up to the present as the light emitting material, development of phosphor material, from the aspect of the mechanism of electroluminescence, is one of the best ways to improve the luminous efficiency up to 4 folds, theoretically.

Up to the present, iridium (III) complexes have been widely known as phosphorescent light emitting material: (acac)Ir(btp)₂, Ir(ppy)₃ and Firpic or the like having been known as RGB, respectively [Baldo et al., Appl. Phys. Lett., Vol 75, No. 1, 4, 1999; WO 00/70 655; WO 02/7 492; Korean Patent Laid-Open No. 2004-14346]. Various phosphors have been researched in Japan, Europe and America, in particular.

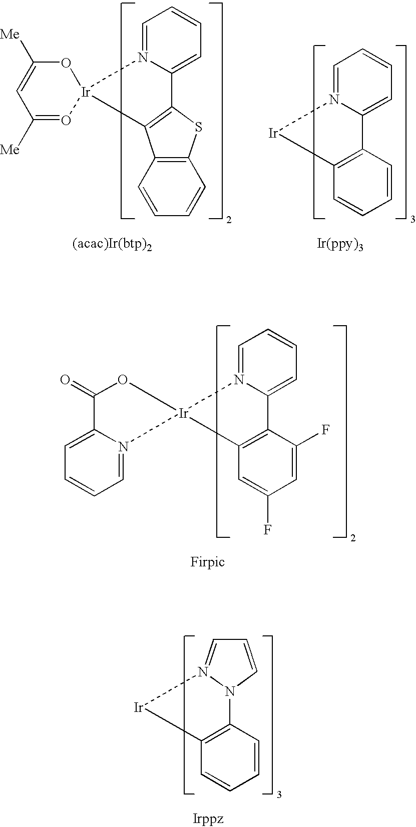

Among the conventional red phosphors, a few substances having good light emitting property have been reported, but very few substances have reached the level of common use. As the best substance, an iridium complex of 2-phenylisoquinoline [Ph-iQ]₃Ir, having very excellent light emitting property to exhibit color purity of deep red and high luminous efficiency, has been known [A. Tsuboyama, et al., J. Am. Chem. Soc., 2003, 125(42), 12971-12979].

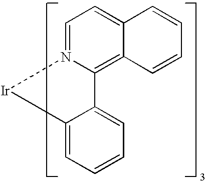

Further, in case of red substance, there is no serious problem in terms of lifetime, so that it tends to be ready to common use if it has excellent color purity or luminous efficiency. Thus, the iridium complex mentioned above is a substance having very high possibility of common use, due to its excellent color purity and luminous efficiency.

Meanwhile, though a wide variety of compounds as shown below have been known as red phosphors having high luminous efficiency in US Patent Laid Open No. 2001/0019782, these compounds cannot satisfy the color purity of pure red and high luminous efficiency at the same time.

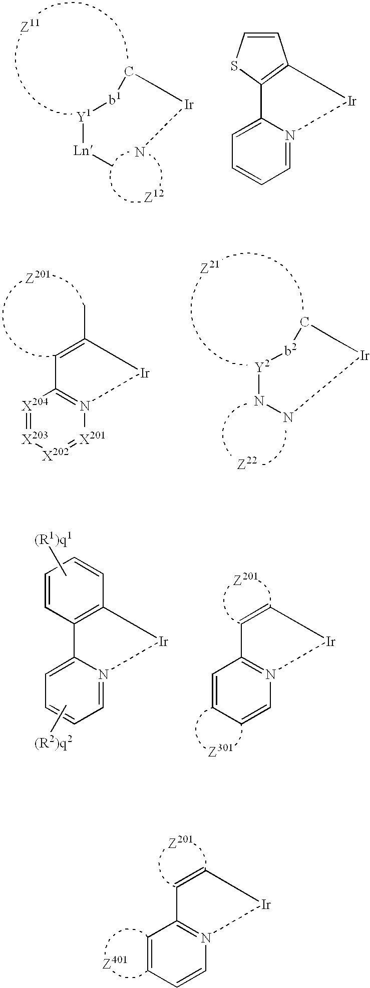

Moreover, as to the iridium complexes, as shown below, having a compound substituted with a naphthyl group or multi-ring compound at 2-position of pyridine, as a ligand, only structures of the compounds have been suggested in US Patent Laid Open No. 2001/0019782, but the compounds are not disclosed specifically. Besides, as examined by the present inventors, those compounds are disadvantageous in that they are not pure red or show lower luminous efficiency.

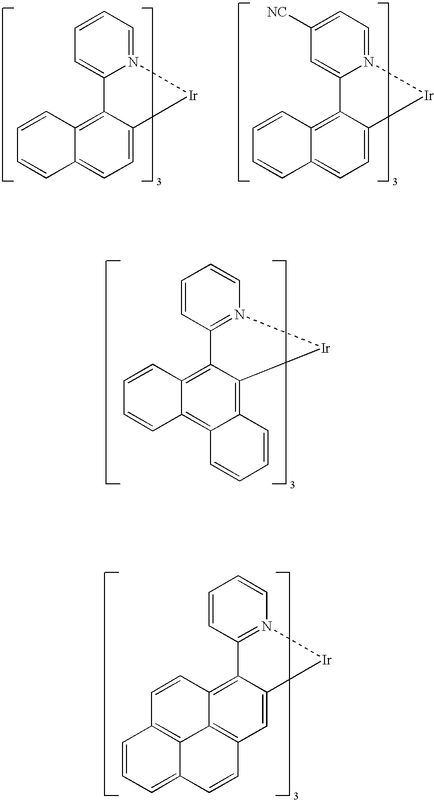

Since they cannot satisfy the condition of pure red color and high luminous efficiency at the same time, those compounds have limitation to be practically employed in a medium or large sized OLED panel, and there is an actual need for a substance having more excellent light emitting property than conventional known substances.

As a result of intensive researches to solve the problems of prior art, the present inventors found that electroluminescent compounds having pure red color and high luminous efficiency can be provided by employing the process of incorporating substituent(s) to specific position(s) of 2-[1-naphthyl]pyridine compounds.

Thus, the object of the invention is to provide red phosphor compounds exhibiting more pure red color than conventional red phosphors. Another object of the invention is to provide red phosphors having a light emitting property of high efficiency even in a low doping concentration, as well as the property of pure red color mentioned above. Still another object of the invention is to provide an OLED display device which employs a novel red phosphor compound that has excellent lifetime property as compared to conventional red phosphor compounds to be advantageously applied to common use, as a light emitting dopant.

### SUMMARY OF THE INVENTION

The present invention relates to a novel red organic electro-phosphor compound represented by Chemical Formula 1:

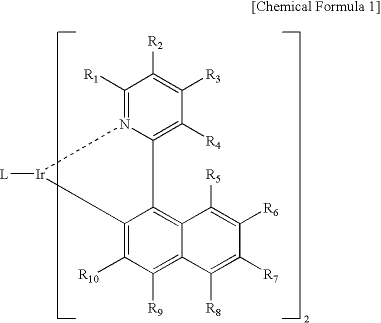

wherein, L is selected from the ligands represented by one of the following formulas:

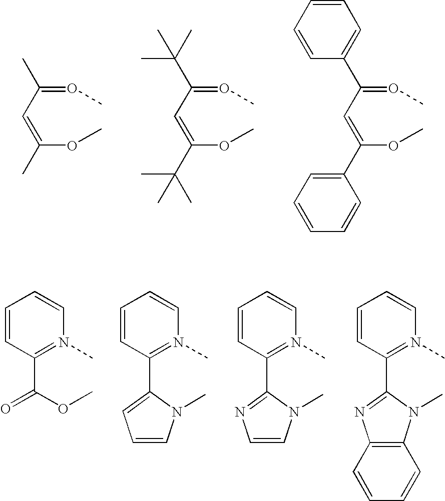

wherein, each one of groups from R₁ to R₁₀ independently represents hydrogen, linear or branched C₁-C₂₀ alkyl group or alkoxy group with or without halogen substituent(s), C₅-C₇ cycloalkyl group, aromatic group with or without halogen substituent(s), halogen, acyl group, cyano group or dicyanoethylene group; or groups from R₅ to R₁₀ are linked via alkylene or alkenylene, in which the substituents of adjacent carbons consist of 2 to 10 carbon atoms, to form a fused ring or multi-fused ring, provided that the compound with both R₄ and R₅ being hydrogen is excluded where the groups do not form a fused ring or a multi-fused ring; and a display device comprising the same.

The novel iridium complexes according to the present invention are red electroluminescent compounds having excellent luminous efficiency.

### BRIEF DESCRIPTION OF THE DRAWINGS

FIG. 1 is a cross-sectional view of an organic EL device;

FIG. 2 is an EL spectrum of an OLED which employs compound [R17]₂[acac]Ir as a dopant;

FIG. 3 shows the property of current density-voltage of an OLED which employs compound [R17]₂[acac]Ir as a dopant;

FIG. 4 shows the property of luminous efficiency-luminance of an OLED which employs compound [R17]₂[acac]Ir as a dopant; and

FIG. 5 shows the property of chromaticity coordinate-luminance of an OLED which employs compound [R17]₂[acac]Ir as a dopant.

### DESCRIPTION OF SYMBOLS OF SIGNIFICANT PARTS OF THE DRAWINGS

1: a glass for organic EL
2: a transparent electrode ITO thin film
3: a hole transport layer
4: a light emitting layer
5: a hole blocking layer
6: an electron transport layer
7: an electron injecting layer
8: a cathode

Other and further objects, features and advantages of the invention will appear more fully from the following description.

### DETAILED DESCRIPTION OF THE PREFERRED EMBODIMENT

The present inventors invented a process to remarkably shift the light emitting wavelength to pure red wavelength by introducing substituent(s) other than hydrogen at the R₄ position of the pyridyl group and R₅ position of the naphthyl group to result in steric hindrance between R₄ substituent and R₅ substituent, so that the pyridyl ring and naphthyl ring would not be laid on the same plane.

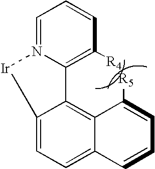

Figures shown below illustrate the calculated results of three-dimensional structure wherein (a) both R₄ and R₅ are hydrogen, or (b) substituent(s) have been introduced to R₄ and/or R₅. According to the figures, (a) when both R₄ and R₅ are hydrogen, the pyridyl group and naphthyl ring are laid on the same plane, while when substituent(s) is (are) introduced to R₄ and/or R₅, the two rings are staggered each other.

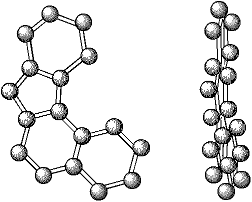

(a) both R₄ and R₅ are hydrogen

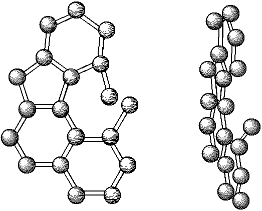

(b) substituent(s) introduced to R₄ and R₅

The present inventors have also invented a method to remarkably increase the luminous efficiency by linking the substituents from R₅ to R₁₀ of the naphthyl group with the substituent(s) of the adjacent carbon via alkylene or alkenylene to form a fused ring or multi-fused ring.

According to the present invention, in a compound represented by Chemical Formula 1, substituent(s) other than hydrogen has(have) been incorporated to one or both of the groups R₄ and R₅ in order to bring about such a steric hindrance. In the pure red light emitting compounds represented by Chemical Formula 1, specifically, each group from R₁ to R₁₀ independently represents hydrogen, linear or branched C₁-C₁₀ alkyl group or alkoxy group, C₅-C₇ cycloalkyl group, halogen, acyl group, cyano group or an aromatic group with or without halogen substituent(s), provided that both R₄ and R₅ cannot represent hydrogen in order to bring about steric hindrance between R₄ substituent of the pyridyl group and R₅ substituent of the naphthyl group by incorporating substituent(s) other than hydrogen at the R₄ and R₅ position of substitution.

Particularly, in order to bring about steric hindrance between R₄ substituent of the pyridyl group and R₅ substituent of the naphthyl group according to the invention, the compounds, from which the compounds with both R₄ and R₅ being hydrogen are excluded, are preferably selected from the compounds represented by Chemical Formula 2 wherein R₁, R₃, R₆, R₇ and R₁₀ are all hydrogen:

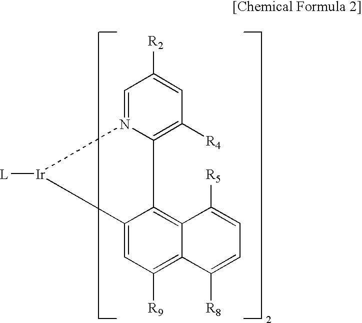

wherein R₂, R₄, R₅, R₈ and R₉ independently represent hydrogen, methyl, ethyl, n-propyl, i-propyl, n-butyl, i-butyl, t-butyl, n-pentyl, i-amyl, n-hexyl, n-heptyl, n-octyl, 2-ethylhexyl, n-nonyl, trifluoromethyl, pentafluoroethyl, cyclopentyl, cyclohexyl, methoxy, ethoxy, trifluoromethoxy, phenyl, 2-methylphenyl, 4-methylphenyl, 2-fluorophenyl, 4-fluorophenyl, 1-naphthyl, 2-naphthyl, fluoro, acetyl group, benzoyl, formyl, pivaloyl or cyano group, provided that the compound with both R₄ and R₅ being hydrogen is excluded.

The phosphor compounds of Chemical Formula 1 according to the present invention, wherein a method to remarkably increase the luminous efficiency by forming a fused ring or multi-fused ring on the naphthyl group has been employed, include the compounds in which substituents from R₅ to R₁₀ of the naphthyl group are linked with the substituent(s) of the adjacent carbon via alkylene or alkenylene consisting of 2 to 10 carbon atoms to form a fused ring or multi-fused ring. Among them, preferable are the phosphor compounds represented by one of Chemical Formulas 3 to 7, wherein substituents R₈ and R₉ form a ring:

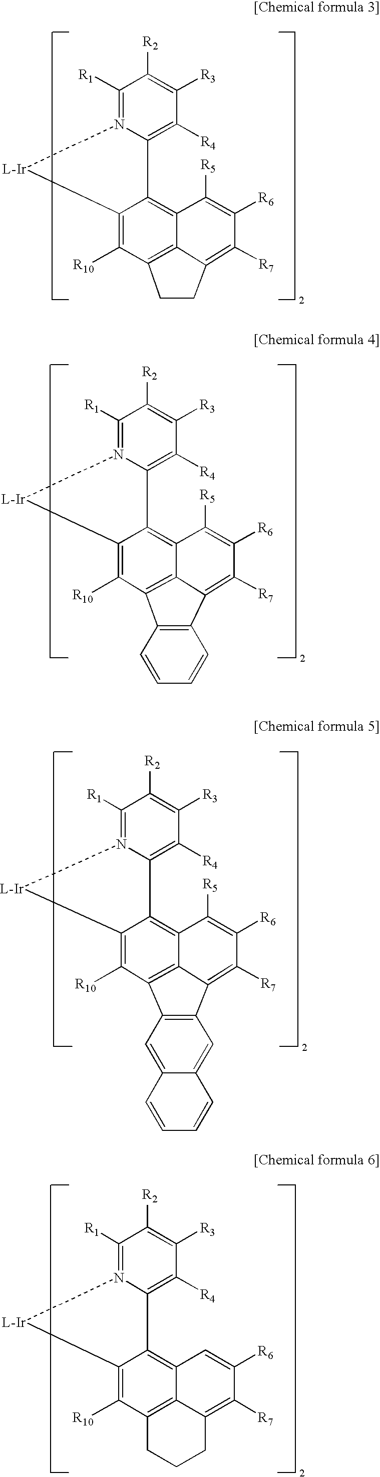

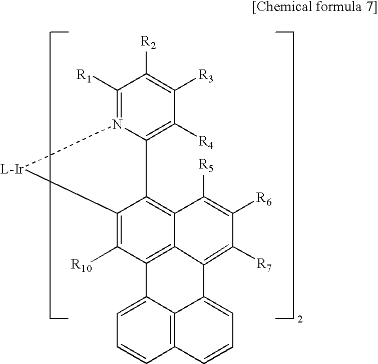

wherein each one from R₁ to R₇ and R₁₀ of the Chemical Formulas 3 to 7 independently represents hydrogen, a linear or branched C₁-C₁₀ alkyl group or alkoxy group with or without halogen substituent(s), C₅-C₇ cycloalkyl group, phenyl group or naphthyl group with or without substituent(s), halogen group, acyl group or cyano group.

In particular, the compounds represented by one of Chemical Formulas 3 to 7 are preferably selected, in view of different light emitting properties, from the phosphor compounds represented by one of Chemical Formulas 8 to 12 wherein R₁, R₃, R₆, R₇ and R₁₀ are all hydrogen:

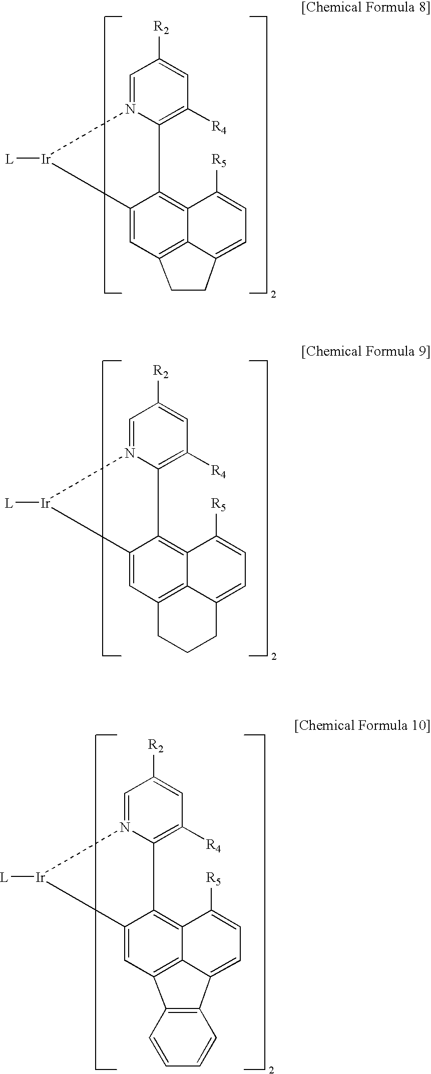

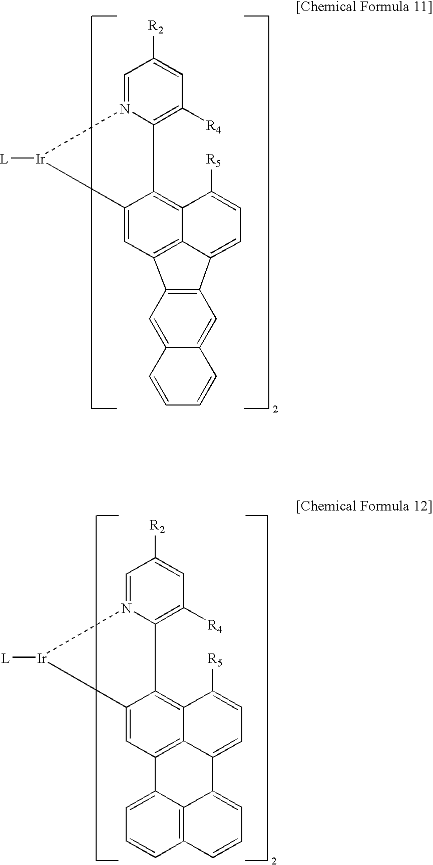

In the Chemical Formulas 8 to 12, R₂, R₄ and R₅ independently represent hydrogen, methyl, ethyl, n-propyl, i-propyl, n-butyl, i-butyl, t-butyl, n-pentyl, i-amyl, n-hexyl, n-heptyl, n-octyl, 2-ethylhexyl, n-nonyl, trifluoromethyl, pentafluoroethyl, cyclopentyl, cyclohexyl, methoxy, ethoxy, trifluoromethoxy, phenyl, 2-methylphenyl, 4-methylphenyl, 2-fluorophenyl, 4-fluorophenyl, 1-naphthyl, 2-naphthyl, fluoro, acetyl group, benzoyl, formyl, pivaloyl or cyano group.

Examples of more preferable phosphor compounds are selected from the compounds below, and the most preferable red phosphor compounds are those in which a fused ring or multi-fused ring has been formed on the pyridyl group, while the substituents bringing about steric hindrance has been incorporated to R₄ and R₅.

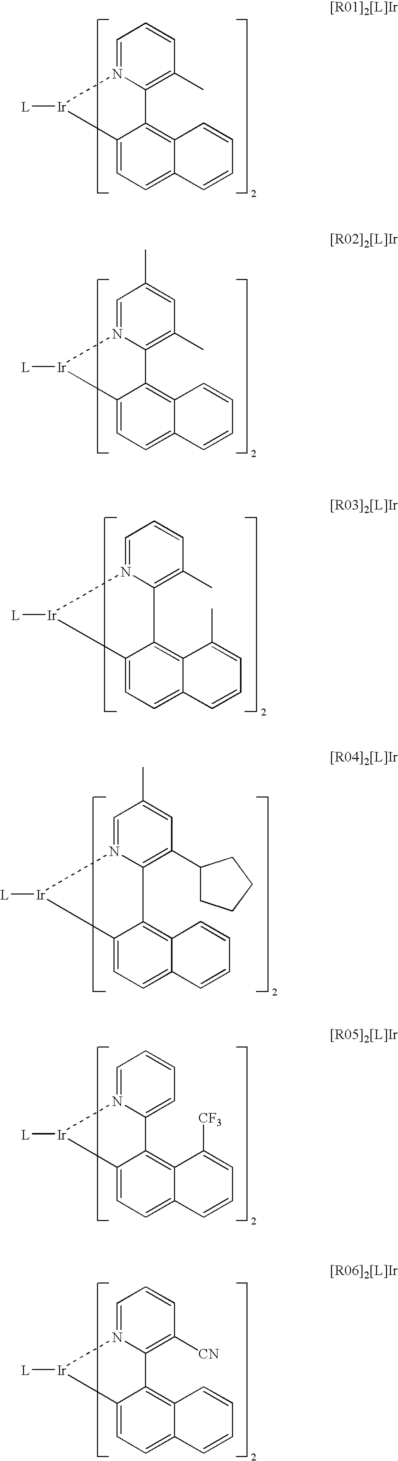

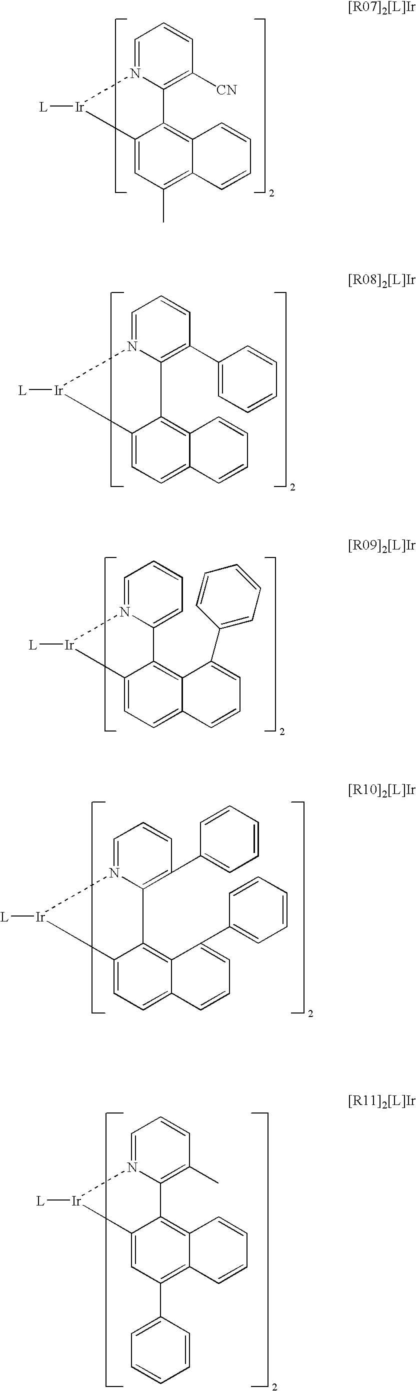

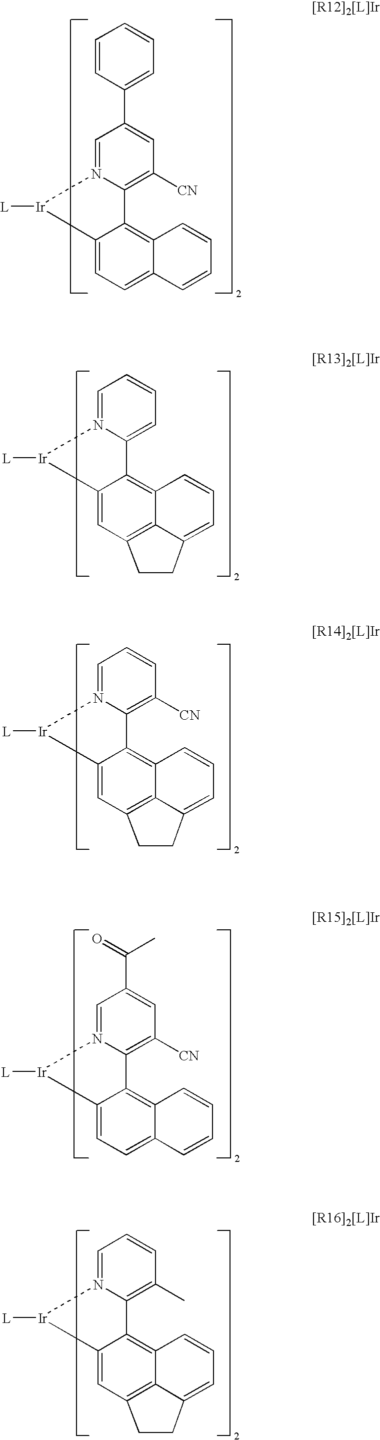

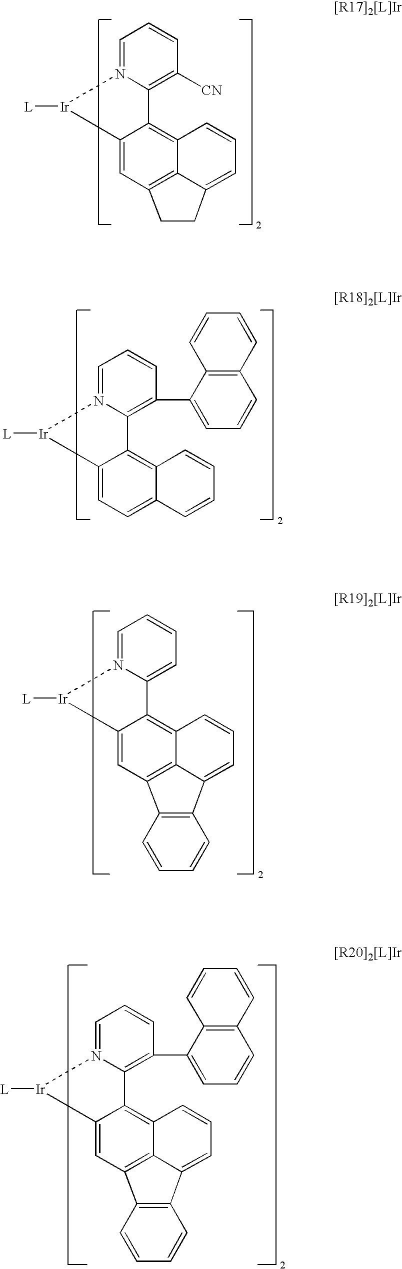

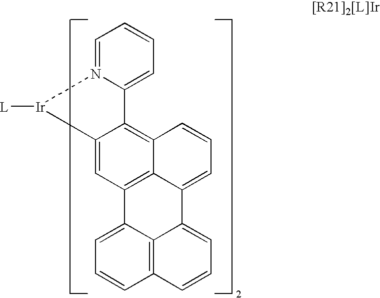

A 2-naphthyl pyridine derivative as a ligand constituting a red electrophosphorescent compound according to the present invention can be prepared by adopting the preparation process illustrated in Reaction Scheme 1:

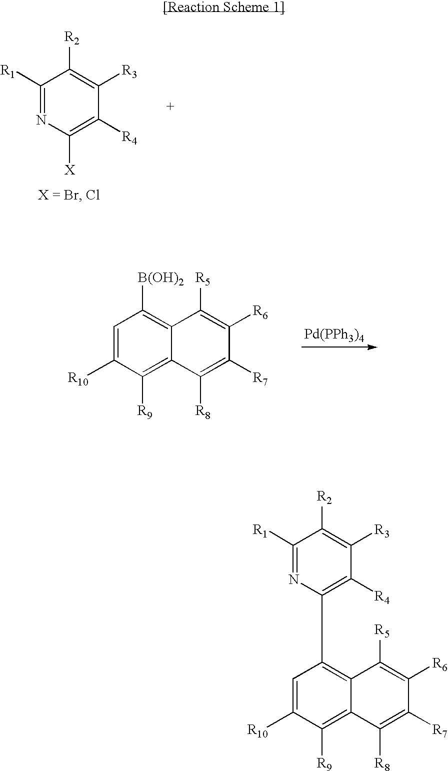

The 2-naphthyl pyridine derivative as a ligand of red phosphor compound according to the present invention is prepared by dissolving 1-naphthalene boronic acid derivative, halopyridine derivative and catalytic amount of tetrakis(triphenylphosphine) palladium in organic solvent such toluene-ethanol mixture, adding sodium carbonate and pyridine to the resultant solution, heating the mixture under reflux to carry out coupling and recrystallize the resultant solid, as illustrated in Reaction Scheme 1.

The process for preparing novel naphthyl pyridine derived ligands according to the invention is not restricted to the process illustrated in Reaction Scheme 1. In addition, the process according to Reaction Scheme 1 may be adapted, or any preparing process via other route may be carried out. Since the preparation can be performed without difficulty by a person having ordinary skill in the art by using conventional methods of organic synthesis, it is not described here in detail.

From the novel ligands thus prepared, iridium complexes can be prepared via the process illustrated by Reaction Scheme 2:

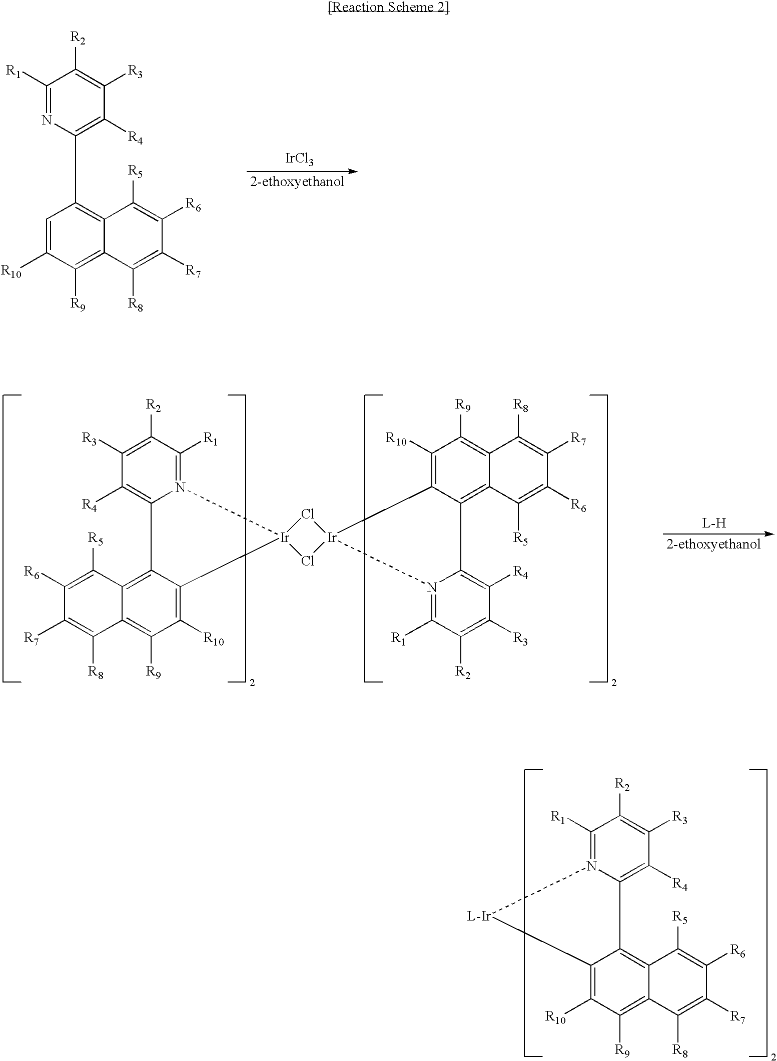

Iridium trichloride (IrCl₃) and the 2-naphthyl pyridine derived ligand thus prepared are mixed in a molar ratio of 1:2˜3, preferably about 1:2.2 with solvent and the mixture is heated under reflux to isolate μ-dichlorodiiridium intermediate. The solvent used in this reaction stage is preferably alcohol or alcohol/water mixed solvent, for example 2-ethoxyethanol or 2-ethoxyethanol/water mixed solvent.

The isolated diiridium dimer is admixed with auxiliary ligand L and organic solvent and heated to prepare electroluminescent iridium compound as the final product. The molar ratio of pyridinyl derived ligand and other ligand L to be reacted is determined according to the composition ratio of the final product. At this time, AgCF₃SO₃, Na₂CO₃, NaOH or the like is reacted as being mixed with 2-ethoxyethanol or diglyme as organic solvent.

Now, the present invention is described as referring to exemplary processes for preparing the novel electroluminescent compounds according to the present invention by way of Examples. These Examples, however, are intended to provide better understanding of the invention, and it should be understood that the scope of the invention is not restricted thereto.

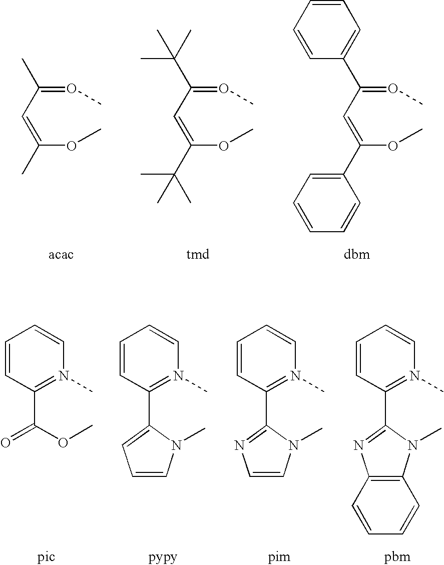

### EXAMPLES

### Example 1

### Preparation of [R06]₂[acac]Ir

Preparation of R06

In a mixed solvent of toluene-ethanol (5:5, 100 mL), dissolved were 1-naphthalene boronic acid (4.7 g, 27.3 mmol), 2-chloro-3-cyanopyridine (3.6 g, 26.0 mmol) and Pd (PPh₃)₄ (tetrakis(triphenylphosphine)palladium) (1.5 g, 1.3 mmol). After adding 2 M aqueous sodium carbonate solution (40 mL) thereto, the resultant mixture was heated under reflux for 16 hours. After quenching the reaction, the reaction mixture was cooled to ambient temperature, extracted with ethyl acetate, and recrystallized from chloroform to obtain R06 primary ligand (4.5 g, 19.5 mmol) as white solid.

¹H NMR (200 MHz, CDCl₃): δ 7.3-7.4 (m, 4H), 7.6-7.7 (m, 3H), 8.0-8.2 (m, 2H), 9.1 (d, 1H)

Preparation of [R06]₂ [acac]Ir

Ligand R06 (3.0 g, 13.0 mmol) prepared from the previous stage and iridium chloride (III) (1.2 g, 5.9 mmol) were dissolved in 45 mL of 2-ethoxyethanol, and the mixture was heated under reflux for 12 hours. Filtration of the resultant solid, washing with water, extraction with methylene chloride, and recrystallization from toluene mixed solution gave 1.7 g of [R06]₂Ir₂Cl₂[R06]₂ as corresponding μ-dichloro diiridium intermediate as red crystals.

In 35 mL of 2-ethoxyethanol, dissolved was μ-dichloro diiridium intermediate (1.7 g) prepared from the previous stage, 2,4-pentadione (acac) (0.41 g, 4.1 mmol) and sodium carbonate (0.75 g), and the resultant mixture was heated under reflux for 4 to 6 hours. The solid precipitate generated was filtered and extracted with methylene chloride. The product was separated by column chromatography and recrystallized from methylene chloride-methanol mixed solution to give red phosphor compound, [R06]₂[acac]Ir (0.52 g, 0.70 mmol, yield: 14%) as the title compound.

¹H NMR (200 MHz, CDCl₃): δ 2.1 (s, 6H), 5.5-5.6 (s, 1H), 7.3-8.5 (m, 18H) MS/FAB: 750 (found), 749.84 (calculated)

### Example 2

### Preparation of [R16]₂[acac]Ir

Preparation of Ligand R16

In a mixed solvent of toluene-ethanol (5:5, 100 mL), dissolved were 5-acenaphthalene boronic acid (3.28 g, 16.6 mmol), 2-bromo-3-methylpyridine (2.59 g, 15.0 mmol) and Pd(PPh₃)₄ (0.52 g, 0.45 mmol). After adding 2 M aqueous sodium carbonate solution (30 mL) thereto, the resultant mixture was heated under reflux for 16 hours. After quenching the reaction, the reaction mixture was cooled to room temperature, extracted with ethyl acetate, and recrystallized from chloroform to obtain R16 (2.1 g, 8.1 mmol) as white solid.

¹H NMR (200 MHz, CDCl₃): δ 2.3 (s, 3H), 3.4 (t, 4H), 6.9 (m, 1H), 7.1 (d, 1H), 7.2 (d, 1H), 7.3 (m, 1H), 7.4-7.5 (m, 2H), 8.1 (d, 2H), 8.5 (d, 1H)

Preparation of [R16]₂[acac]Ir

By using ligand R16 (2.0 g, 7.7 mmol) prepared from the previous stage, the same procedure as described in Example 1 was repeated to obtain the title red phosphor compound [R16]₂[acac]Ir (0.41 g, 0.53 mmol, yield: 15%).

¹H NMR (200 MHz, CDCl₃): δ 2.1 (s, 6H), 2.35 (s, 6H), 3.4 (t, 8H), 5.5-5.6 (s, 1H), 7.1-8.4 (m, 14H) MS/FAB: 781 (found), 779.95 (calculated)

### Example 3

### Preparation of [R18]₂[acac]Ir

Preparation of Ligand R18

In a mixed solvent of toluene-ethanol (5:5, 100 mL), dissolved were 1-naphthalene boronic acid (4.28 g, 24.9 mmol), 2,3-dichloropyridine (1.84 g, 12.45 mmol) and Pd(PPh₃)₄ (0.71 g, 0.62 mmol). After adding 2 M aqueous sodium carbonate solution (60 mL) thereto, the resultant mixture was heated under reflux for 48 hours. After quenching the reaction, the reaction mixture was cooled to ambient temperature, extracted with ethyl acetate, and recrystallized from chloroform to obtain R18 (3.0 g, 9.1 mmol) as white solid.

¹H NMR (200 MHz, CDCl₃): δ 7.05 (m, 1H), 7.3-7.7 (m, 14H), 8.1 (d, 2H), 8.5-8.6 (m, 2H)

### Preparation of [R18]₂[acac]Ir

By using ligand R18 (3.0 g, 9.1 mmol) prepared from the previous stage, the same procedure as described in Example 1 was repeated to obtain the title red phosphor compound [R18]₂[acac]Ir (1.26 g, 1.32 mmol, yield: 41%).

¹H NMR (200 MHz, CDCl₃): δ 2.1 (s, 6H), 5.5-5.6 (s, 1H), 7.3-8.5 (m, 32H) MS/FAB: 953 (found), 952.14 (calculated)

### Example 4

### Preparation of [R19]₂[acac]Ir

Preparation of Ligand R19

In a mixed solvent of toluene-ethanol (5:5, 80 mL), dissolved were 1-fluoranthene boronic acid (2.36 g, 9.59 mmol) which was prepared by 1-bromination of fluoranthene, 2-bromopyridine (1.52 g, 9.62 mmol) and Pd(PPh₃)₄ (0.27 g, 0.24 mmol). After adding 2 M aqueous sodium carbonate solution (60 mL) thereto, the resultant mixture was heated under reflux for 24 hours. After quenching the reaction, the reaction mixture was cooled to ambient temperature, extracted with ethyl acetate, and recrystallized from chloroform to obtain ligand R19 (2.2 g, 7.85 mmol) as white solid.

¹H NMR (200 MHz, CDCl₃): δ 6.95 (q, 1H), 7.25 (s, 4H), 7.45-7.55 (m, 2H), 7.8 (d, 1H), 7.9 (d, 1H), 8.0 (d, 1H), 8.3 (d, 1H), 8.55 (d, 1H)

Preparation of [R19]₂[acac]Ir

By using ligand R19 (2.2 g, 7.85 mmol) prepared from the previous stage, the same procedure as described in Example 1 was repeated to obtain the title compound [R19]₂[acac]Ir (1.5 g, 1.77 mmol, yield: 49%).

¹H NMR (200 MHz, CDCl₃): δ 2.1 (s, 6H), 5.5-5.6 (s, 1H), 7.0-7.15 (m, 2H), 7.3-7.4 (s, 8H), 7.5-8.5 (m, 14H) MS/FAB: 848 (found), 847.98 (calculated)

### Comparative Example 1

### Preparation of [2-(1-naphthyl)pyridine]₂[acac]Ir

In a mixed solvent of toluene-ethanol (5:5, 100 mL), dissolved were 1-naphthalene boronic acid (1.90 g, 11.0 mmol), 2-bromopyridine (1.58 g, 10.0 mmol) and Pd(PPh₃)₄ (0.64 g, 0.55 mmol). After adding 2 M aqueous sodium carbonate solution (30 mL) and pyridine (1 mL) thereto, the resultant mixture was heated under reflux for 1 day. After quenching the reaction, the reaction mixture was cooled to ambient temperature, extracted with ethyl acetate, and recrystallized from chloroform to obtain title compound (each group from R₁ to R₁₀ being hydrogen) (1.74 g, 8.5 mmol) of white solid as a ligand.

The ligand, 2-[1-(naphthyl)pyridine] (1.12 g, 5.5 mmol), prepared in the previous stage and iridium chloride (III) (0.74 g, 2.5 mmol) were dissolved in 20 mL of 2-ethoxyethanol, and the solution was heated under reflux for 12 hours. Filtration of the resultant solid, washing with water, extraction with methylene chloride, and recrystallization from toluene mixed solution gave 1.1 g (yield: 63%) of corresponding μ-dichloro diiridium intermediate, [2-(1-naphthyl)pyridine]₂Ir₂Cl₂[2-(1-naphthyl)pyridine]₂ as red crystals.

In 20 mL of 2-ethoxyethanol, dissolved were μ-dichloro diiridium intermediate (1.1 g) thus prepared, 2,4-pentadione (0.25 g, 2.5 mmol) and sodium carbonate (0.44 g), and the resultant mixture was heated under reflux for 4 to 6 hours. The solid precipitate generated was filtered and extracted with methylene chloride. The product was separated by column chromatography and recrystallized from methylene chloride-methanol mixed solution to give the title compound, [2-(1-naphthyl)pyridine]₂[acac]Ir (each group from R₁ to R₁₀ being hydrogen) (0.58 g, 0.83 mmol, yield: 30%).

¹H NMR (200 MHz, CDCl₃): δ 2.1 (s, 6H), 5.5-5.6 (s, 1H), 6.9-7.9 (m, 20H) MS/FAB: 702 (found), 701.83 (calculated)

### Example 5

### Manufacture of OLED

OLED devices were manufactured by using the light emitting substance prepared according to the present invention and from Comparative Example 1, as a light emitting dopant.

A transparent electrode ITO thin film (15 Ω/□) obtained from glass for OLED (manufactured from Samsung-Corning) was subjected to ultrasonic washing sequentially with trichloroethylene, acetone, ethanol and distilled water, and stored in isopropanol.

Then, an ITO substrate is equipped on a substrate folder of a vacuum vapor deposition device, and 4,4′,4″-tris(N,N-(2-naphthyl)-phenylamino)triphenylamine (2-TNATA) was charged in a cell of the vacuum vapor deposition device. After ventilation to reach the degree of vacuum in the chamber of 10⁻⁶ torr, electric current was applied to the cell to evaporate 2-TNATA to vapor-deposit a hole injecting layer on the ITO substrate with 60 nm of thickness.

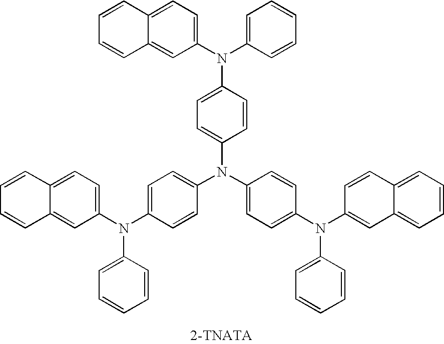

Then, N,N′-bis(α-naphthyl)-N,N′-diphenyl-4,4′-diamine (NPB) was charged in another cell of said vacuum vapor deposition device, and electric current was applied to the cell to evaporate NPB to vapor-deposit a hole transport layer on the hole injecting layer with 20 nm of thickness.

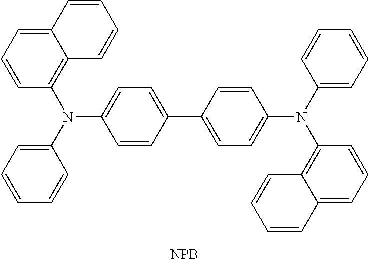

Further, 4,4′-N,N′-dicarbazole-biphenyl (CBP) as a light emitting host substance was charged in another cell of the vacuum vapor deposition device, while one of the red phosphor compounds according to the present invention or the light emitting substance prepared from Comparative Examples 1 in still another cell. The two substances were doped by evaporating them in different rates, to vapor deposit a light emitting layer (4) having 30 nm of thickness on the hole transport layer. The doping concentration of 4 to 10 mol % was appropriate on the basis of CBP.

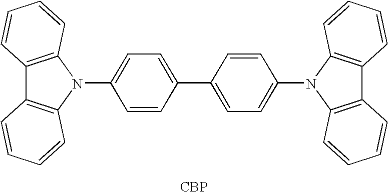

Then, in the same manner as in the case of NPB, bis(2-methyl-8-quinolinato)(p-phenylphenolato)aluminum (III) (BAlq) as a hole blocking layer was vapor deposited with a thickness of 10 nm on the light emitting layer, and subsequently tris(8-hydroxyquinoline)aluminum (III) (Alq) as an electron transport layer was vapor deposited with a thickness of 20 nm. Lithium quinolate (Liq) as an electron injecting layer was then vapor deposited with a thickness of 1 to 2 nm, and Al cathode was vapor deposited with a thickness of 150 nm by using another vapor deposition device, to manufacture an OLED.

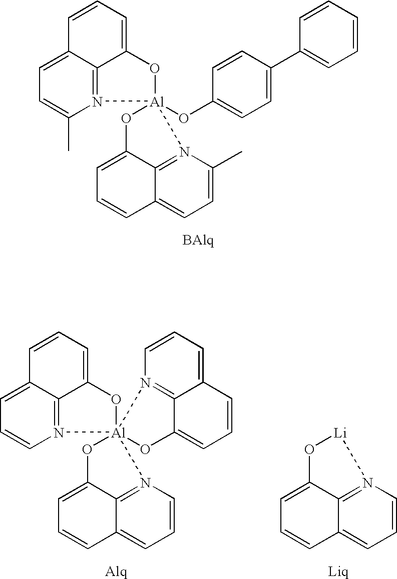

### Example 6

### Evaluation of Optical Properties of Light Emitting Substances

The complexes having high synthetic yield among the substances were purified by vacuum sublimation under 10⁻⁶ torr, and used as a dopant of an OLED light emitting layer. With respect to the substances having low synthetic yield, only the light emitting peak was checked. The light emitting peak was measured by preparing a methylene chloride solution having the concentration of 10⁻⁴M or less. At the time of measuring light emission of every substance, the excitation wavelength was 250 nm.

Luminous efficiencies of the OLEDs were measured at 10 mA/cm², and the properties of various electroluminescent compounds according to the present invention are shown in Table 1:

TABLE 1

| | | Light | Electro- | |
|---|---|---|---|---|
| Primary | | emitting | luminescence | Lumious |
| ligand | Light emitting | wavelength | wavelength | efficiency |
| No. | compound | (nm) | (nm) | (cd/A) |
| R01 | [R01]₂[acac]Ir | 612 | 608 | 4.11 |
| R06 | [R06]₂[acac]Ir | 630 | 624 | 4.05 |
| R07 | [R07]₂[acac]Ir | 633 | — | — |
| R08 | [R08]₂[acac]Ir | 620 | — | — |
| R16 | [R16]₂[acac]Ir | 602 | 602 | 9.10 |
| R17 | [R17]₂[acac]Ir | 633 | 616 | 8.58 |
| R18 | [R18]₂[acac]Ir | 622 | 630 | 1.60 |
| R19 | [R19]₂[acac]Ir | 680 | 692 | 0.79 |
| — | Comparative | 595 | 592 | 11.2 |
| | Example 1 | | | |

As can be seen from Table 1, it is confirmed that the phosphor compounds according to the present invention employing the ligands such as R01, R06, R08 or the like, wherein steric hindrance was generated between R₄ substituent of the pyridyl group and R₅ substituent of naphthyl group by introducing the substituents other than hydrogen at the position of R₄ of pyridyl group and R₅ of the naphthyl group, so that the pyridyl ring and the naphthyl ring would not be laid on the same plane, exhibits the phenomenon of remarkable shift of light emitting wavelength toward pure red color. As comparing the light emitting wavelength, that of the compound of Comparative Example 1 which has no steric hindrance with no substituent at all was shifted to orange color (595 nm), while that of [R01]₂[acac]Ir, [R08]₂[acac]Ir and [R06]₂[acac]Ir had the shift of light wavelength to 612 nm, 620 nm and 630 nm, respectively.

Further, the present inventors found that the iridium complexes according to the invention in which the ligand such as R16 and R17 wherein the substituents R₅ to R₁₀ of the naphthyl group are linked with the substituent(s) of the adjacent carbon via alkylene or alkenylene to form a fused ring or a multi-fused ring to remarkably increase the luminous efficiency, showed significant degree of improvement in luminous efficiency in an EL device. As can be confirmed by Table 1, by means of forming a fused ring or a multi-fused ring on the naphthyl group, the luminous efficiency of [R16]₂[acac]Ir and [R17]₂[acac]Ir were increased to 9.10 cd/A and 8.58 cd/A, respectively, which showed about 2-fold-increase of luminous efficiency as compared to conventional level of luminous efficiency of 4 cd/A.

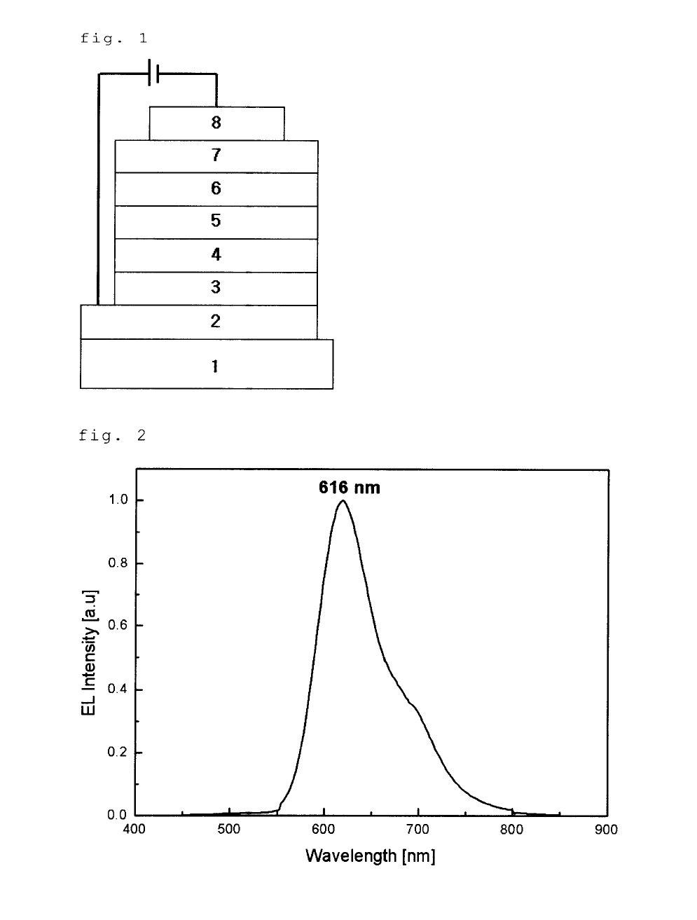

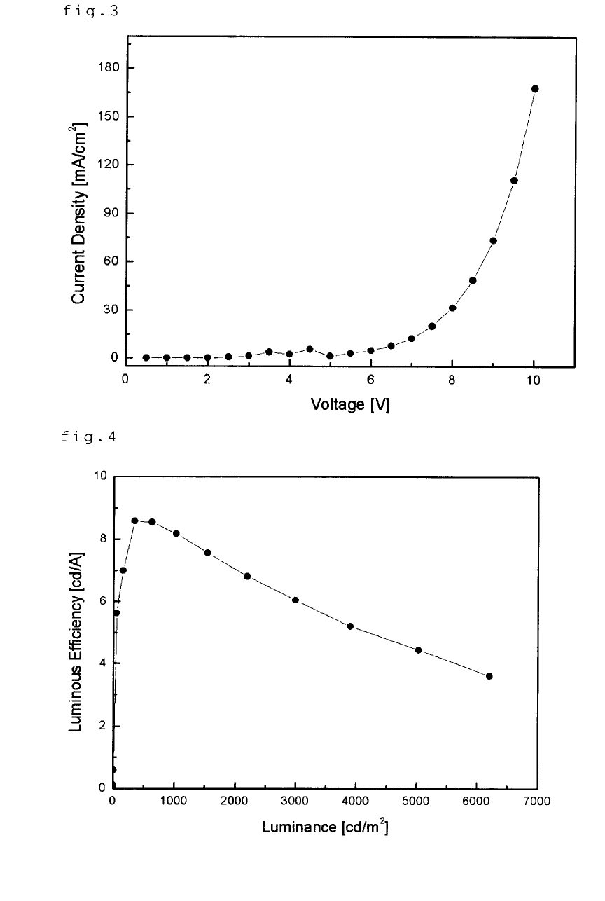

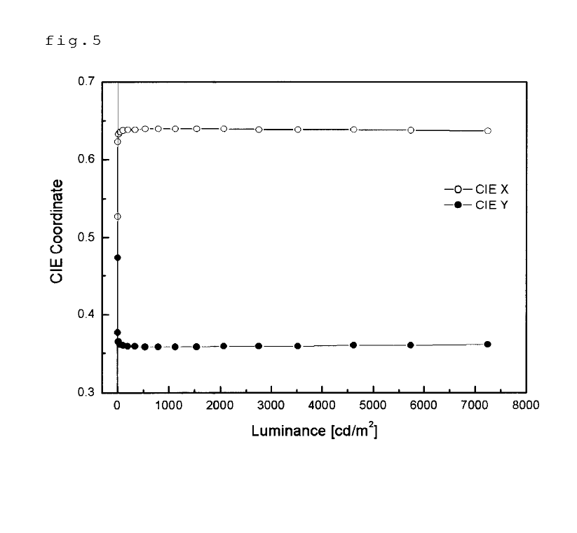

FIG. 1 shows the cross-sectional view of an organic EL device, and FIGS. 2 to 5 shows EL spectrum of OLED employing the red phosphor compound [R17]₂[acac]Ir according to the invention as a dopant, the property of current density-voltage of the OLED, and property of luminous efficiency-luminance of the OLED.

In addition, it was found that when the red phosphor compound according to the invention was employed as a dopant, the current property has been improved in a conventional CBP:dopant/HBL structure.

### INDUSTRIAL APPLICABILITY

As described above, the novel red phosphor compound according to the present invention can provide a red phosphor compound showing more pure red color as compared to conventional red phosphors, which has high luminous efficiency even in a low doping concentration as well. Use of the red phosphor compounds according to the present invention provides an advantage of excellent current property even in conventional CBP:dopant/HBL structure, so that the compounds can contribute the development of large sized OLED devices.

1. A red phosphor compound represented by Chemical Formula 1:
[Chemical Formula 1] 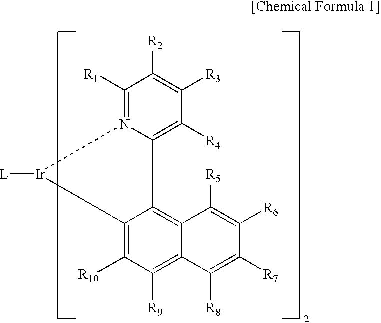
wherein, L is selected from the ligands of following formulas: 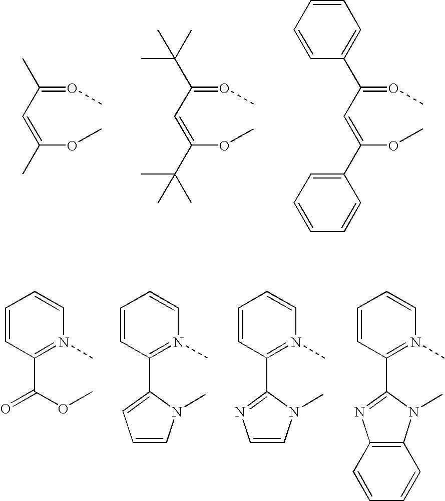
wherein, each one of groups from R₁ to R₁₀ independently represents hydrogen, linear or branched C₁-C₂₀ alkyl group or alkoxy group with or without halogen substituent(s), C₅-C₇ cycloalkyl group, aromatic group with or without halogen substituent(s), halogen, acyl group, cyano group or dicyanoethylene group; or groups from R₅ to R₁₀ are linked via alkylene or alkenylene, in which the substituents of adjacent carbons consist of 2 to 10 carbon atoms, to form a fused ring or multi-fused ring, provided that the compound with both R₄ and R₅ being hydrogen is excluded where the groups do not form a fused ring or a multi-fused ring.

2. A red phosphor compound according to claim 1, wherein each one of groups from R₁ to R₁₀ independently represents hydrogen, linear or branched C₁-C₁₀ alkyl group or alkoxy group, C₅-C₇ cycloalkyl group, halogen, acyl group, cyano group or an aromatic group with or without halogen substituent(s), provided that the compound with both R₄ and R₅ being hydrogen is excluded.

3. A red phosphor compound according to claim 1, which is represented by one of Chemical Formulas 3 to 7: 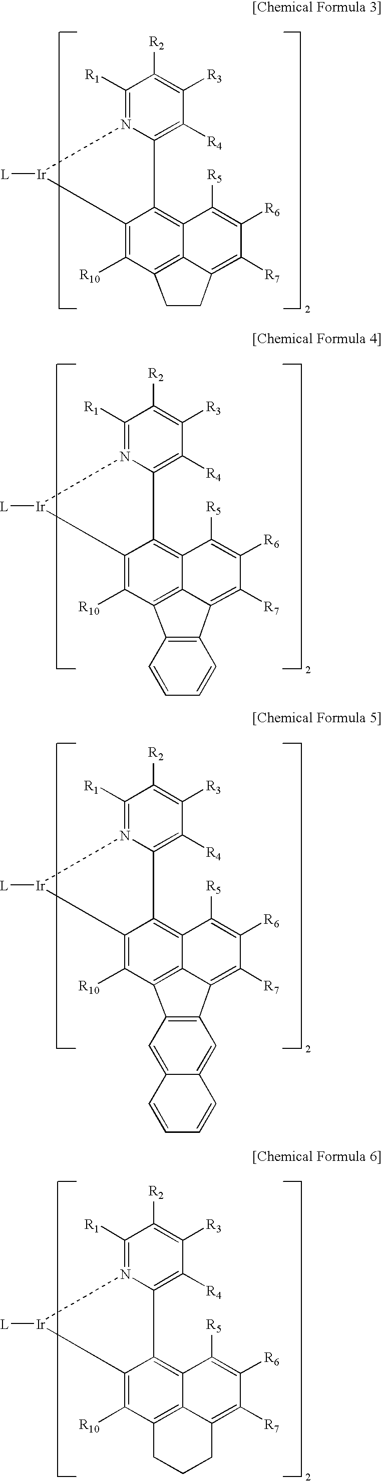 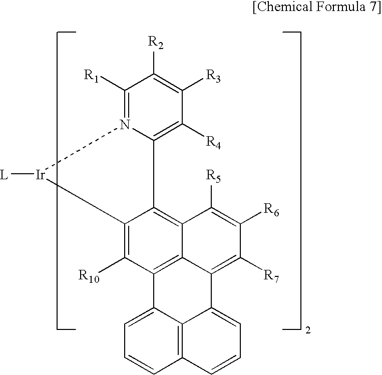
wherein each one from R₁ to R₇ and R₁₀ of Chemical Formulas 3 to 7 independently represents hydrogen, a linear or branched C₁-C₁₀ alkyl group or alkoxy group with or without halogen substituent(s), C₅-C₇ cycloalkyl group, phenyl group or naphthyl group with or without substituent(s), halogen group, acyl group or cyano group.

4. A red phosphor compound according to claim 2, which is selected from Chemical Formula 2, and Chemical Formulas 8 to 12: 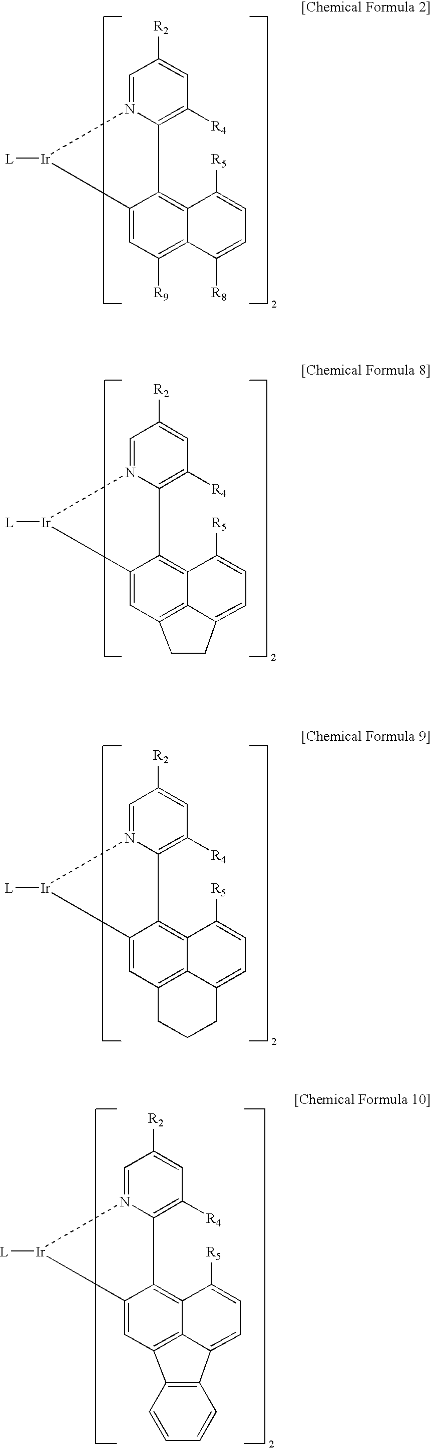 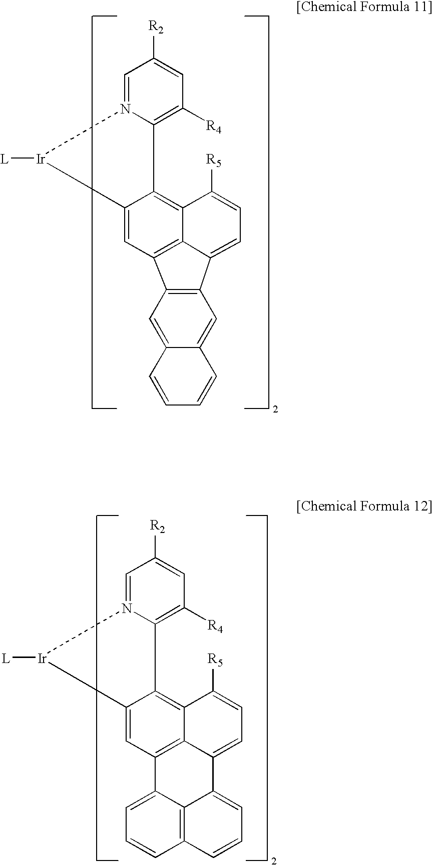
wherein R₂, R₄, R₅, R₈ and R₉ independently represents hydrogen, methyl, ethyl, n-propyl, i-propyl, n-butyl, i-butyl, t-butyl, n-pentyl, i-amyl, n-hexyl, n-heptyl, n-octyl, 2-ethylhexyl, n-nonyl, trifluoromethyl, pentafluoroethyl, cyclopentyl, cyclohexyl, methoxy, ethoxy, trifluoromethoxy, phenyl, 2-methylphenyl, 4-methylphenyl, 2-fluorophenyl, 4-fluorophenyl, 1-naphthyl, 2-naphthyl, fluoro, acetyl group, benzoyl, formyl, pivaloyl or cyano group, provided that the compound having both R₄ and R₅ being hydrogen is excluded from the compounds of Chemical Formula 2.

5. A red phosphor compound according to claim 4, which is selected from the compounds represented by one of the following chemical formulas:

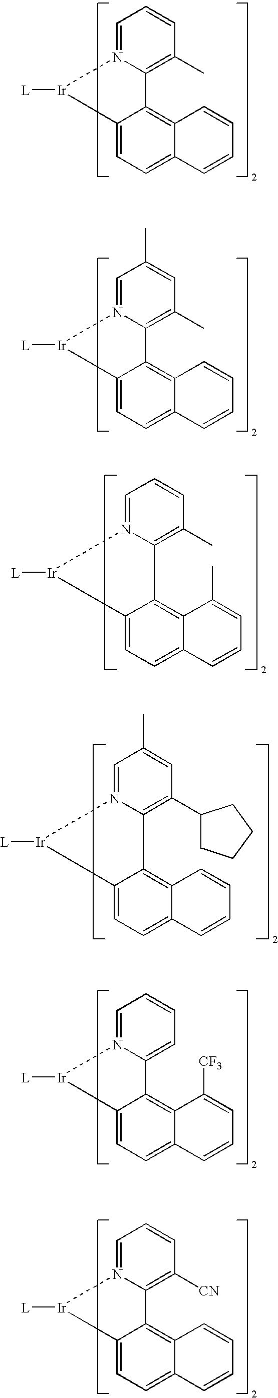

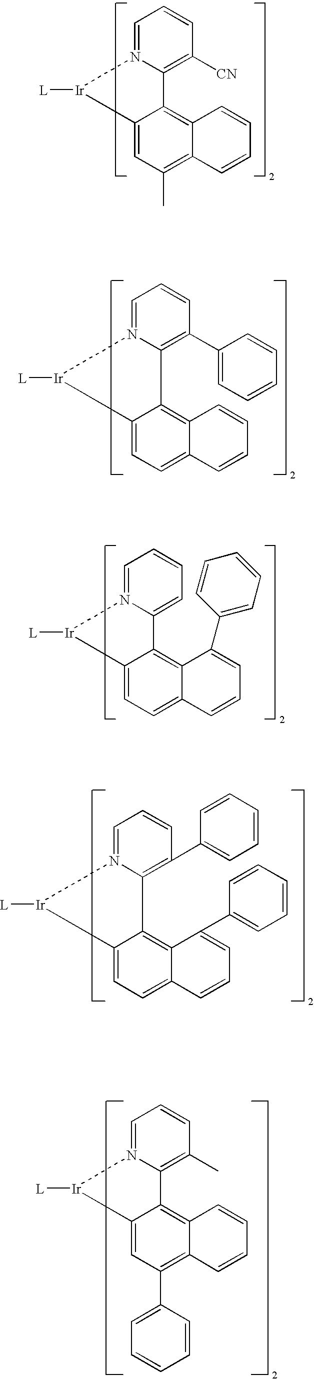

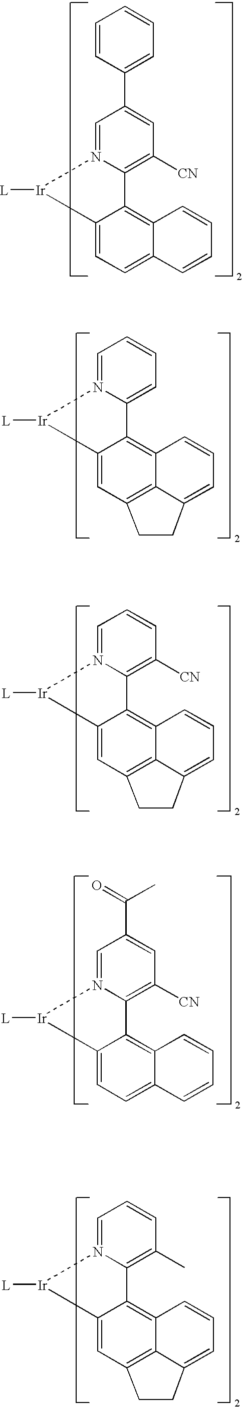

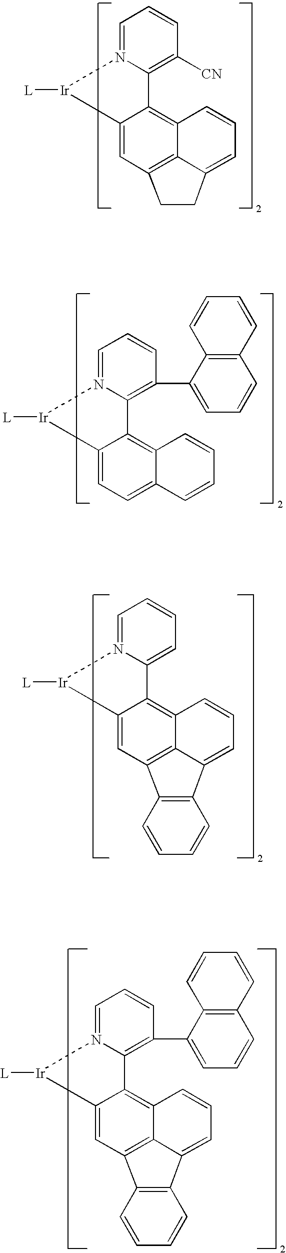

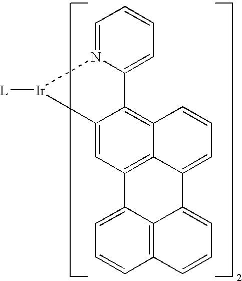

6. A display device comprising a red phosphor compound according to claim 1.

7. A red phosphor compound according to claim 3, which is selected from Chemical Formula 2, and Chemical Formulas 8 to 12: 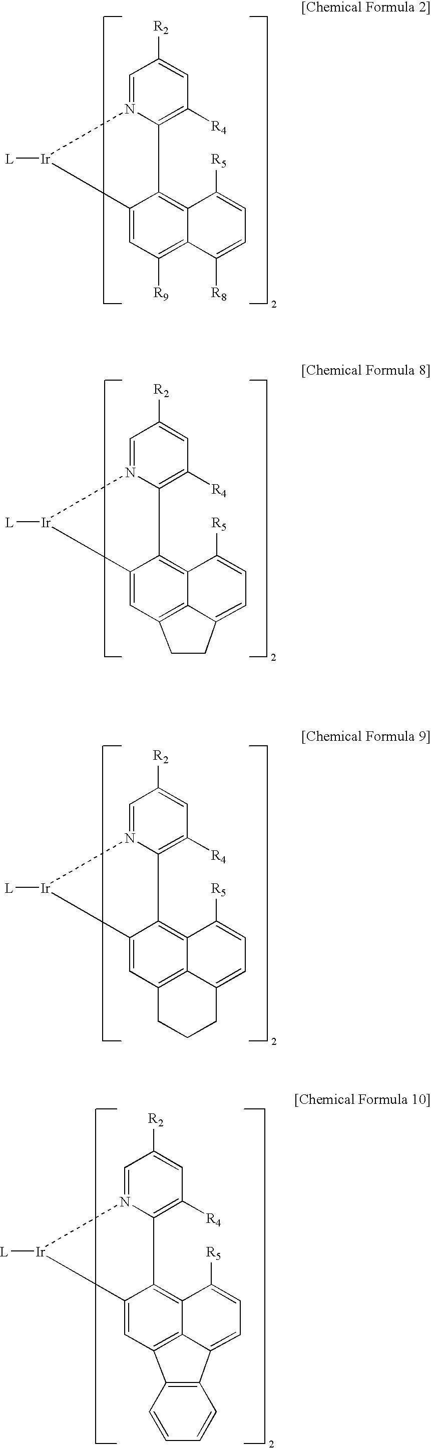 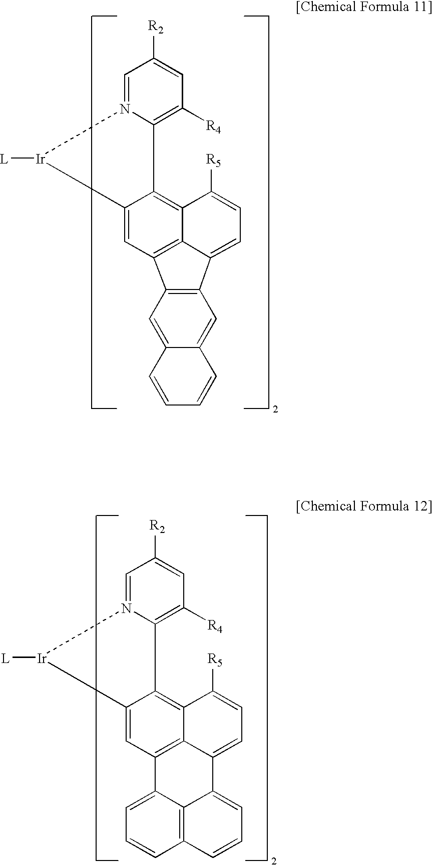
wherein R₂, R₄, R₅, R₈ and R₉ independently represents hydrogen, methyl, ethyl, n-propyl, i-propyl, n-butyl, i-butyl, t-butyl, n-pentyl, i-amyl, n-hexyl, n-heptyl, n-octyl, 2-ethylhexyl, n-nonyl, trifluoromethyl, pentafluoroethyl, cyclopentyl, cyclohexyl, methoxy, ethoxy, trifluoromethoxy, phenyl, 2-methylphenyl, 4-methylphenyl, 2-fluorophenyl, 4-fluorophenyl, 1-naphthyl, 2-naphthyl, fluoro, acetyl group, benzoyl, formyl, pivaloyl or cyano group, provided that the compound having both R₄ and R₅ being hydrogen is excluded from the compounds of Chemical Formula 2.

8. A display device comprising a red phosphor compound according to claim 2.

9. A display device comprising a red phosphor compound according to claim 3.

10. A display device comprising a red phosphor compound according to claim 4.

11. A display device comprising a red phosphor compound according to claim 5.

12. A display device comprising a red phosphor compound according to claim 7.
